(19) United States
(12) Patent Application Publication
(10) Pub. No.: US 2011/0182327 A1
(43) Pub. Date: Jul. 28, 2011

(54) RADIO TRANSMISSION DEVICE AND RADIO TRANSMISSION METHOD

(75) Inventors: Atsushi Matsumoto, Ishikawa (JP); Souhei Fukurotani, Ishikawa (JP); Daichi Imamaura, Kanagawa (JP); Sadaki Futagi, Ishikawa (JP); Takashi Iwai, Ishikawa (JP)

(73) Assignee: PANASONIC CORPORATION, Osaka (JP)

(21) Appl. No.: 13/121,369

(22) PCT Filed: Sep. 28, 2009
(86) PCT No.: PCT/JP2009/004929

§ 371 Date: Mar. 28, 2011

(30) Foreign Application Priority Data
Sep. 29, 2008 (JP) 2008-250616

(51) Int. Cl. H04W 72/04; H04B 1/713

(52) U.S. Cl. 375/132; 370/329; 375/E01.033

(57) ABSTRACT

Provided are a radio transmission device and a radio transmission method which can reduce the transmission packet collision generation ratio even when a reception of scheduling information has failed in the retransmission method using a combination of the adaptive HARQ and the non-adaptive HARQ. In ST301, a resource control unit (206) stores resource allocation information and scheduling timing information transmitted from a base station (100). ST302 checks whether the scheduling information has been acquired. ST303 applies the adaptive HARQ. ST304 checks whether the scheduling information not acquired in ST302 has been acquired at the timing indicated by the scheduling timing information. In ST305, a resource control unit (206) instructs stop of the packet transmission. In ST306, the resource control unit (206) employs the non-adaptive HARQ.

### TECHNICAL FIELD

The present invention relates to a radio transmitting apparatus and radio transmitting method that use a retransmission method combining adaptive HARQ (adaptive Hybrid Auto Repeat reQuest) and non-adaptive HARQ (non-adaptive Hybrid Auto Repeat reQuest).

### BACKGROUND ART

HARQ is an error control technology. HARQ is a technology that improves error correction capability and implements high-quality transmission by having the transmitting side retransmit an erroneous packet, and having a received packet and the retransmission packet combined on the receiving side. This HARQ technology has been adopted in HSDPA (High Speed Downlink Packet Access) and LTE (Long Term Evolution).

Two HARQ methods have been studied: adaptive HARQ and non-adaptive HARQ. Adaptive HARQ is a method whereby a retransmission packet is allocated to an arbitrary resource, while non-adaptive HARQ is a method whereby a retransmission packet is allocated to a predetermined resource.

With adaptive HARQ, a packet is allocated to a resource having good channel quality at the time of transmission, enabling the packet error rate to be improved and the number of retransmissions to be reduced. However, since a packet is allocated to an arbitrary resource, signaling for reporting a packet allocation resource position is necessary for each packet transmission, resulting in a problem of increased signaling overhead.

On the other hand, with non-adaptive HARQ, since a packet is allocated to a predetermined resource, channel quality at the time of transmission cannot be said necessarily to be good, and the packet error rate is average, resulting in a tendency for the number of retransmissions to increase. However, since a packet is allocated to a predetermined resource, it is not necessary to report a packet allocation resource position for each packet transmission, providing an advantage of low signaling overhead.

Thus, there is a trade-off regarding number of retransmissions and signaling overhead between adaptive HARQ and non-adaptive HARQ. In view of this, semi-adaptive HARQ combining adaptive HARQ and non-adaptive HARQ has been proposed as a method that resolves this trade-off.

Here, semi-adaptive HARQ will be described assuming uplink packet transmission. With semi-adaptive HARQ, a base station executes signaling to report a resource position—that is, scheduling information—only when the base station wishes to change resource allocation. If a mobile station (hereinafter referred to as “UE: User Equipment”) is unable to receive signaling from the base station, the UE determines that scheduling information addressed to that UE has not been transmitted from the base station, and transmits a packet by means of a predetermined resource. On the other hand, if the UE has been able to receive signaling from the base station, the UE transmits a packet using a resource position reported by the signaling. That is to say, the UE switches between adaptive HARQ and non-adaptive HARQ according to the presence or absence of signaling from the base station.

Thus, since semi-adaptive HARQ allows a base station to transmit signaling and change a packet allocation resource position only when necessary, it is possible to reduce the number of retransmissions with little signaling overhead.

### CITATION LIST

### Non-Patent Literature

NPL 1

3GPP TS 36.300 V8.3.0 Technical Specification Group Radio Access Network; E-UTRA and E-UTRAN; Overall description; Stage 2 (Release 8), “11 Scheduling and Rate Control”

### SUMMARY OF INVENTION

### Technical Problem

However, a problem with the above-described technology is that, if a UE fails to receive resource allocation signaling, since a packet is transmitted by means of a predetermined resource, a packet collision occurs when another UE transmits a packet using the same resource.

It is an object of the present invention to provide a radio transmitting apparatus and radio transmitting method that enable the transmission packet collision incidence rate to be reduced even when reception of scheduling information has failed in a retransmission method using a combination of adaptive HARQ and non-adaptive HARQ.

### SOLUTION TO PROBLEM

A radio transmission apparatus of the present invention employs a configuration having: a resource control section that generates resource control information for controlling a resource based on a timing of acquiring scheduling information and whether or not the scheduling information is acquired; a resource selection section that selects a resource based on the resource control information; and a transmitting section that transmits data using the selected resource; wherein the resource control section gives an instruction to stop a transmission of the data if the scheduling information is not acquired at the timing.

A radio transmission method of the present invention has: generating resource control information for controlling a resource based on a timing of acquiring scheduling information and whether or not the scheduling information is acquired; selecting a resource based on the resource control information; and transmitting data using the selected resource; wherein a transmission of the data is stopped if the scheduling information is not acquired at the timing.

### ADVANTAGEOUS EFFECTS OF INVENTION

The present invention enables the transmission packet collision incidence rate to be reduced even when reception of scheduling information has failed in a retransmission method using a combination of adaptive HARQ and non-adaptive HARQ.

### BRIEF DESCRIPTION OF DRAWINGS

FIG. 1 is a block diagram showing the configuration of a base station according to Embodiment 1 of the present invention;

FIG. 2 is a block diagram showing the configuration of a UE according to Embodiment 1 of the present invention;

FIG. 3 is a flowchart showing the operating procedure of the resource control section shown in FIG. 2;

FIG. 4 is a drawing provided to explain operation of the base station shown in FIG. 1 and the UE shown in FIG. 2;

FIG. 5 is a drawing provided to explain other operation of the base station shown in FIG. 1 and the UE shown in FIG. 2;

FIG. 6 is a block diagram showing the configuration of a base station according to Embodiment 2 of the present invention;

FIG. 7 is a block diagram showing the configuration of a UE according to Embodiment 2 of the present invention;

FIG. 8 is a drawing showing scheduling information signaling timing; and

FIG. 9 is a drawing showing how non-adaptive HARQ is applied.

### DESCRIPTION OF EMBODIMENTS

Now, embodiments of the present invention will be described in detail with reference to the accompanying drawings. In the embodiments, configuration elements having the same functions are assigned the same reference codes, and duplicate descriptions thereof are omitted.

### Embodiment 1

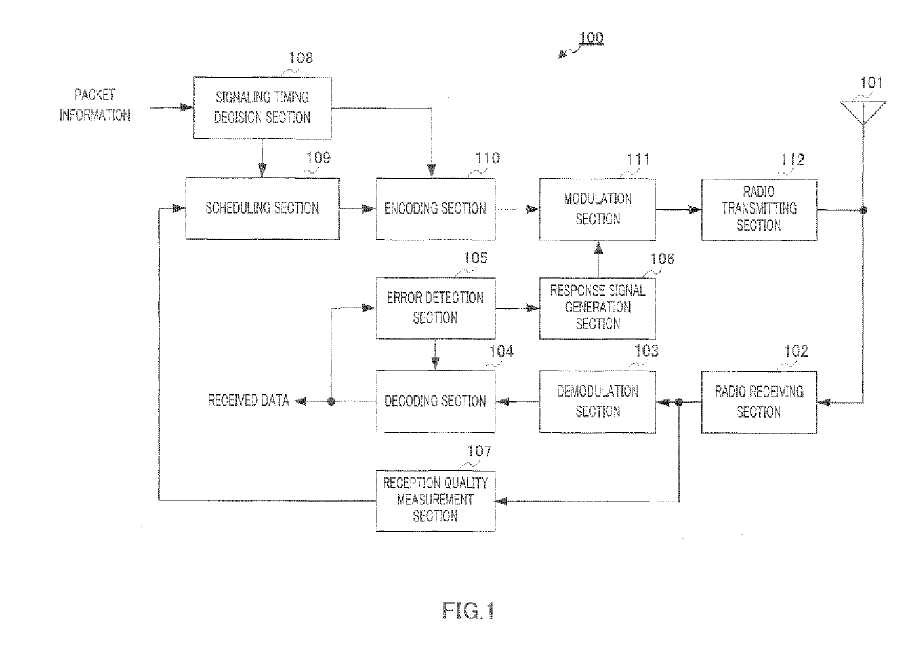

The configuration of base station apparatus (hereinafter referred to simply as “base station”) 100 according to Embodiment 1 of the present invention will now be described using FIG. 1. FIG. 1 is a block diagram showing the configuration of base station 100 according to Embodiment 1 of the present invention. In FIG. 1, radio receiving section 102 receives a signal transmitted from a UE from antenna 101, executes reception processing such as down-conversion and A/D conversion on the received signal, and outputs the signal to demodulation section 103. Radio receiving section 102 also outputs a reference signal for reception quality measurement that is included in the received signal to reception quality measurement section 107.

Demodulation section 103 executes demodulation processing on the signal output from radio receiving section 102, and outputs the demodulation result to decoding section 104. Decoding section 104 executes turbo decoding, convolutional code maximum-likelihood decoding, or suchlike error correction decoding on the demodulation result output from demodulation section 103 and acquires decoded data, and outputs the decoded data to error detection section 105. If a detection result indicating no error is acquired from error detection section 105 described later herein, the decoded data is output as received data.

Error detection section 105 detects whether or not decoded data (a decoded packet) is erroneous based on a CRC (Cyclic Redundancy Check) code or the like added to the decoded data output from decoding section 104, and outputs the decoding result to decoding section 104 and response signal generation section 106.

Response signal generation section 106 generates NACK to indicate that the detection result output from error detection section 105 indicates the presence of an error, or ACK to indicate that the detection result indicates no error, and outputs ACK or NACK to modulation section 111.

Reception quality measurement section 107 measures reception quality, such as the SINR (Signal to Interference and Noise Ratio) of a resource capable of transmitting a packet or the like, based on the reception quality measurement reference signal output from radio receiving section 102, and outputs the measurement result to scheduling section 109.

Signaling timing decision section 108 decides the timing at which base station 100 reports scheduling information to a UE (signaling timing) based on packet information such as the UE's speed of movement, transport block size (TBS), QoS, and the like, outputs the decided signaling timing to scheduling section 109, and also outputs the signaling timing to encoding section 110 as scheduling timing information.

Scheduling section 109 is provided with non-adaptive HARQ and adaptive HARQ functions, and switches between non-adaptive HARQ and adaptive HARQ in accordance with the signaling timing output from signaling timing decision section 108. Scheduling section 109 may also decide upon arbitrary timing, and switch between non-adaptive HARQ and adaptive HARQ at the decided timing.

When non-adaptive HARQ is applied, a resource of a transmission packet transmitted by each UE is decided beforehand, and therefore scheduling section 109 does not output resource allocation information. However, resource allocation information is reported to a UE before a retransmission process starts.

On the other hand, when adaptive HARQ is applied, scheduling section 109 decides a resource of a packet sent by each UE based on a reception quality measurement result output from reception quality measurement section 107, and outputs a decided resource to encoding section 110 as scheduling information. For scheduling information, an identifier identifying a UE (UE ID) is multiplexed, and reported to a UE for each retransmission packet.

When scheduling timing information is output from signaling timing decision section 108, encoding section 110 executes turbo code, convolutional code, or suchlike error correction encoding on the scheduling timing information. Also, when scheduling information is output from scheduling section 109, encoding section 110 executes turbo code, convolutional code, or suchlike error correction encoding on the scheduling information. Encoding section 110 outputs encoded data thereby obtained to modulation section 111.

Modulation section 111 executes QPSK, 16QAM, or suchlike modulation processing on the encoded data output from encoding section 110, and outputs a modulated signal to radio transmitting section 112. Radio transmitting section 112 executes transmission processing such as D/A conversion, up-conversion, and amplification on the modulated signal output from modulation section 111, and performs radio transmission of the signal on which transmission processing has been executed from antenna 101.

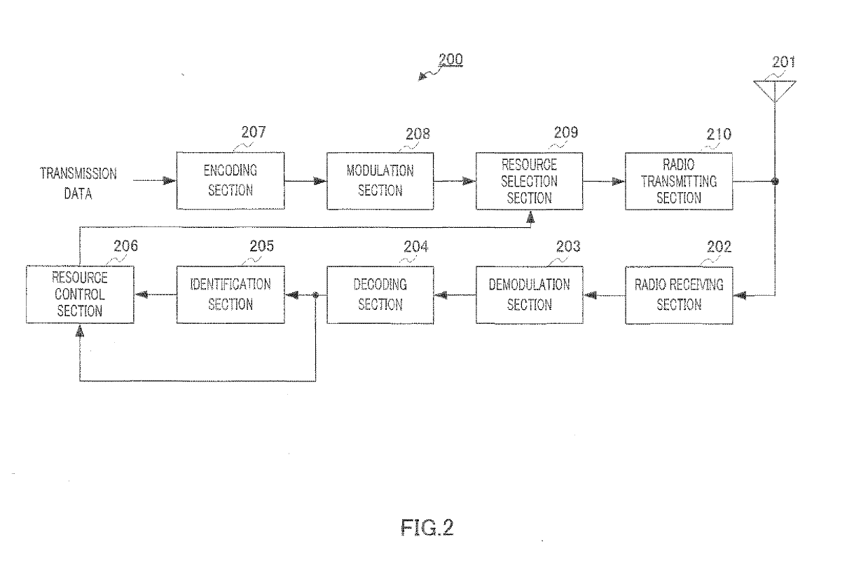

Next, the configuration of UE 200 according to Embodiment 1 of the present invention will be described using FIG. 2. FIG. 2 is a block diagram showing the configuration of UE 200 according to Embodiment 1 of the present invention. In FIG. 2, radio receiving section 202 receives a control signal transmitted from base station 100 from antenna 201, executes reception processing such as down-conversion and A/D conversion on the received control signal, and outputs the signal to demodulation section 203.

Demodulation section 203 executes demodulation processing on the control signal output from radio receiving section 202, and outputs the demodulation result to decoding section 204. Decoding section 204 executes turbo decoding, convolutional code maximum-likelihood decoding, or suchlike error correction decoding on the demodulation result output from demodulation section 203 and acquires decoded data, and, of the acquired decoded data, outputs scheduling information included at the time of adaptive HARQ application to identification section 205. Also, of the acquired decoded data, decoding section 204 outputs predetermined resource allocation information and scheduling timing information used at the time of non-adaptive HARQ application to resource control section 206.

Identification section 205 determines whether or not scheduling information output from decoding section 204 is information addressed to this UE based on an identifier (UE ID) multiplexed in the scheduling information. If the scheduling information is determined to be addressed to this UE, the scheduling information is output to resource control section 206.

Resource control section 206 decides a packet resource allocation position, or decides to stop packet transmission, in accordance with predetermined resource allocation information and scheduling timing information for non-adaptive HARQ use output from decoding section 204, and scheduling information for adaptive HARQ use output from identification section 205, generates resource control information indicating the content of the decision, and outputs this resource control information to resource selection section 209.

Specifically, if scheduling information is not output from identification section 205 at other than timing at which scheduling information is acquired, resource control section 206 applies non-adaptive HARQ, and outputs predetermined resource allocation information to resource selection section 209. On the other hand, if scheduling information is output from identification section 205, resource control section 206 applies adaptive HARQ, and outputs a resource indicated by the scheduling information to resource selection section 209. Furthermore, if scheduling information is not output from identification section 205 at timing at which scheduling information is acquired, resource control information directing stoppage of packet transmission is output to resource selection section 209.

Encoding section 207 executes turbo code, convolutional code, or suchlike error correction encoding on transmission data, and outputs the encoded data to modulation section 208. Modulation section 208 executes QPSK, 16QAM, or suchlike modulation processing on the encoded data output from encoding section 207, and outputs a modulated signal to resource selection section 209.

Resource selection section 209 selects a resource to which the modulated signal output from modulation section 208 is to be allocated based on resource control information output from resource control section 206, allocates the modulated signal to the selected resource, and outputs the signal to radio transmitting section 210.

Radio transmitting section 210 executes transmission processing such as D/A conversion, up-conversion, and amplification on the modulated signal output from resource selection section 209, and performs radio transmission of the signal on which transmission processing has been executed from antenna 201.

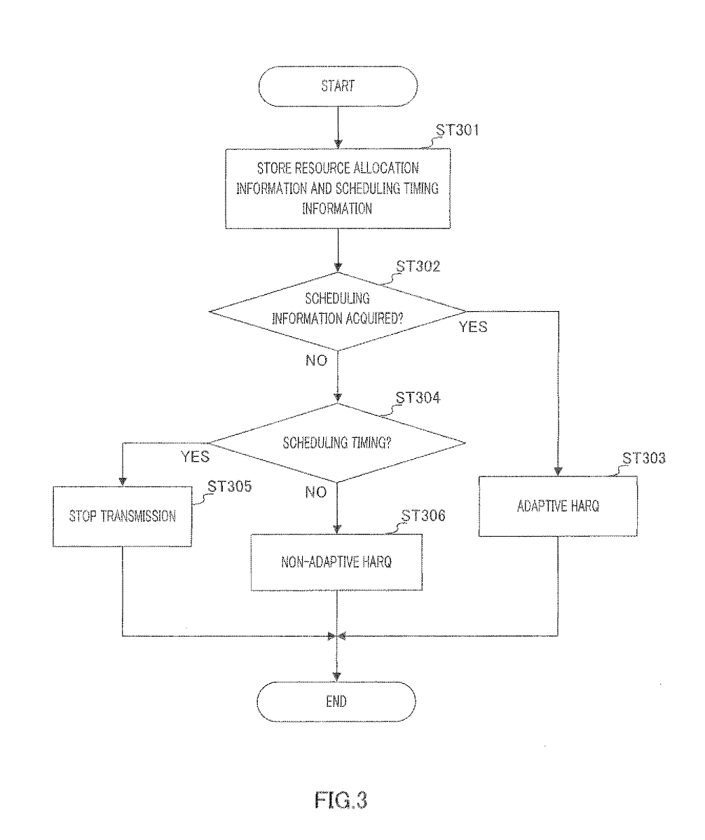

Next, the operation of above resource control section 206 will be described using FIG. 3. FIG. 3 is a flowchart showing the operating procedure of resource control section 206 shown in FIG. 2. In FIG. 3, in step (hereinafter abbreviated to “ST”) 301, resource control section 206 acquires and stores resource allocation information and scheduling timing information transmitted from base station 100.

In ST 302, resource control section 206 determines whether or not scheduling information has been acquired from identification section 205, and proceeds to ST 303 if scheduling information has been acquired (YES), or proceeds to ST 304 if scheduling information has not been acquired (NO).

In ST 303, resource control section 206 applies adaptive HARQ, reports the resource indicated by the scheduling information acquired in ST 302 to resource selection section 209, and terminates resource control section 206 operation.

In ST 304, resource control section 206 determines whether or not scheduling information that was not able to be acquired in ST 302 was not able to be acquired at timing indicated by the scheduling timing information stored in ST 301 (scheduling timing). If scheduling information was not able to be acquired at scheduling timing (YES), resource control section 206 proceeds to ST 305, whereas if scheduling information was not able to be acquired at other than timing indicated by the scheduling information (NO), resource control section 206 proceeds to ST 306.

In ST 305, resource control section 206 sends a packet transmission stoppage directive to resource selection section 209, and terminates resource control section 206 operation.

In ST 306, resource control section 206 applies non-adaptive HARQ, reports the resource stored in ST 301 to resource selection section 209, and terminates resource control section 206 operation.

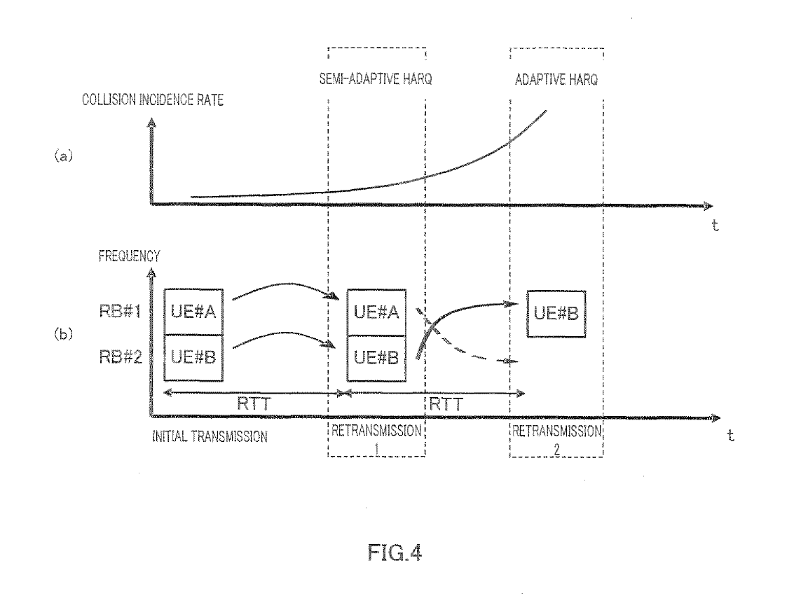

Next, operation of base station 100 shown in FIG. 1 and UE 200 shown in FIG. 2 will be described using FIG. 4. First, FIG. 4(a) shows a packet collision incidence rate with semi-adaptive HARQ. Here, the horizontal axis represents time (t), and the vertical axis represents the collision incidence rate. As shown in FIG. 4(a), the packet collision incidence rate is not uniform over time, but differs according to the number of retransmissions. The timing at which the collision incidence rate increases is after the elapse of a certain time after a resource is allocated by means of signaling—that is to say, after number of retransmissions N for which repeated resource allocation is necessary (in FIG. 4(a), N=2). The reason for this is that resource allocation by means of signaling is generally executed based on channel quality and the allocation status of a plurality of UEs at the time of packet transmission so as to be optimal at that point in time.

Here, when a packet error occurs and retransmission is performed, time has elapsed since a point in time at which a resource was allocated, and divergence has arisen between channel quality at the time of resource allocation and channel quality at the present time due to temporal fluctuation of a channel. Consequently, after the elapse of a certain time, it becomes necessary to perform reallocation. When this resource reallocation is performed, signaling for resource reporting is concentrated on a plurality of UEs. Therefore, at this timing, the number of UEs that should receive signaling increases, and therefore the number of UEs that fail to receive signaling also increases accordingly, and the packet collision incidence rate increases.

FIG. 4(b) shows frequency and time resources used for packet transmission by a plurality of UEs. Here, the situation for two UEs, UE #A and UE #B, is shown. It is assumed that RB (Resource Block) #1 and RB #2 are used as frequency resources, and that initial transmission timing, and first retransmission and second retransmission timings, are used as time resources. It is also assumed that a retransmission is performed in an. RTT (Round Trip Time) interval.

The base station allocates RB #1 to UE #A beforehand as a retransmission resource, and reports resource allocation information to UE #A beforehand. Similarly, the base station allocates RB #2 to UE #B beforehand as a retransmission resource, and reports resource allocation information to UE #B beforehand. Furthermore, it is assumed that the base station reports scheduling information (“grant”) at the second retransmission timing, and reports this timing to UE #A and UE #B beforehand.

At the first retransmission timing, scheduling information is not reported from the base station, and therefore packet transmission is performed in accordance with resource allocation information reported beforehand. If scheduling information has been reported from the base station, packet transmission is performed in accordance with the scheduling information.

Then, at the second retransmission timing, the base station signals scheduling information. Here, it is assumed that RB #2 is allocated to UE #A while RB #1 is allocated to UE #B. Since UE #A and UE #B know beforehand that scheduling information is to be reported, they perform packet transmission in accordance with scheduling information reported from the base station. Here, it is assumed that UE #B has been able to receive scheduling information correctly, and transmits a packet by means of RB #1. On the other hand, it is assumed that UE #A has failed to receive scheduling information, and stops packet transmission.

Thus, according to Embodiment 1, scheduling information signaling timing is reported to a UE from a base station beforehand, and if the UE fails to receive scheduling information at the reported signaling timing, the UE can avoid a collision with a transmission packet of another UE by stopping packet transmission.

As the number of retransmissions increases, the number of retransmission packets decreases, and therefore scheduling information signaling transmitted to each UE also decreases. Thus, if scheduling information has been able to be identified at timing earlier than the timing reported beforehand (not including the reported timing), resource control section 206 of UE 200 performs control so as to transmit a packet in accordance with the scheduling information. Also, if scheduling information has not been able to be identified, resource control section 206 performs control so as to transmit a packet in accordance with a resource reported beforehand. Furthermore, if scheduling information has not been able to be identified at timing from the timing reported beforehand onward (including the reported timing), resource control section 206 performs control so as to stop packet transmission.

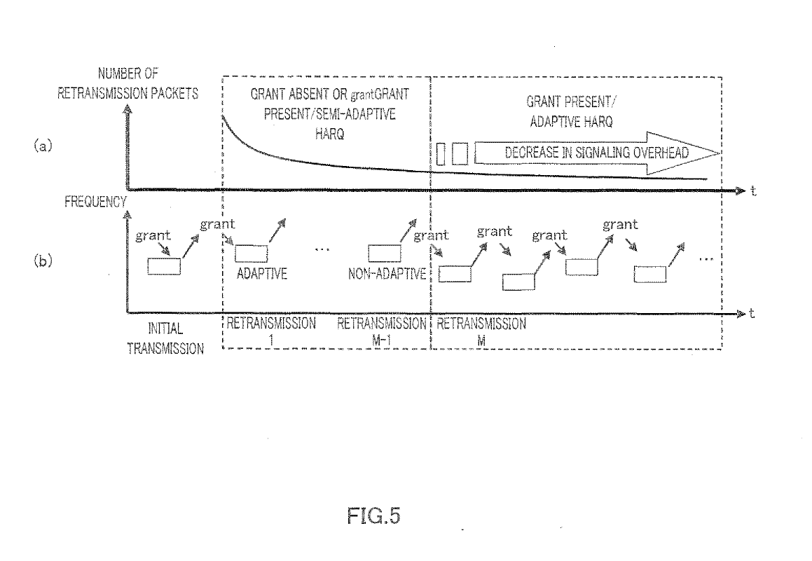

This will snow be described in concrete terms using FIG. 5. FIG. 5(a) shows the number of retransmission packets decreasing as the number of retransmissions increases, and FIG. 5(b) shows frequency resources and time resources used by a UE for packet transmission, and the presence or absence of scheduling information (“grant”).

Base station 100 allocates a retransmission resource to UE 200, and reports resource allocation information to UE 200 beforehand. Furthermore, it is assumed that base station 100 reports scheduling information at M'th retransmission or subsequent timing, and reports this timing to UE 200 beforehand.

If scheduling information has been reported from base station 100 at timing earlier than the M'th retransmission, UE 200 transmits a packet in accordance with the scheduling information. In the case shown in FIG. 5, scheduling information is reported in the first retransmission, and scheduling information is not reported in the (M−1)'th retransmission.

On the other hand, at timings from the M'th retransmission onward, base station 100 signals scheduling information. Since UE 200 knows beforehand that scheduling information is to be reported, it transmits a packet in accordance with scheduling information reported from base station 100. If reception of scheduling information reported from base station 100 fails, UE 200 stops packet transmission.

By setting signaling of scheduling information in a period in which the number of retransmission packets decreases in this way, an increase in signaling overhead can be suppressed, and the number of UE transmission packet collisions can be reduced.

### Embodiment 2

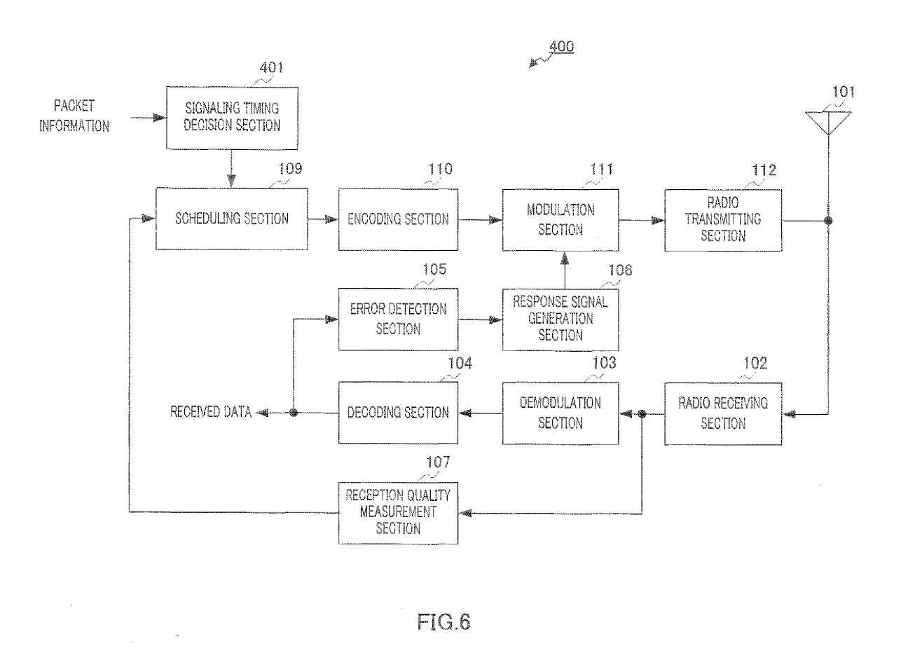

The configuration of base station 400 according to Embodiment 2 of the present invention will now be described using FIG. 6. FIG. 6 is a block diagram showing the configuration of base station 400 according to Embodiment 2 of the present invention. FIG. 6 differs from FIG. 1 in that signaling timing decision section 108 has been changed to signaling timing decision section 401.

Signaling timing decision section 401 associates scheduling information signaling timing with parameters such as transmission packet transport block size (TBS), QoS delay, presence or absence of frequency hopping, path loss during transmission/reception, and the like, and decides signaling timing based on these parameters. The decided signaling timing is output to scheduling section 109.

Unlike signaling timing decision section 108 of base station 100 according to Embodiment 1, signaling timing decision section 401 does not output signaling timing (scheduling timing information) to encoding section 110. That is to say, base station 400 according to this embodiment does not explicitly report scheduling timing information to a UE.

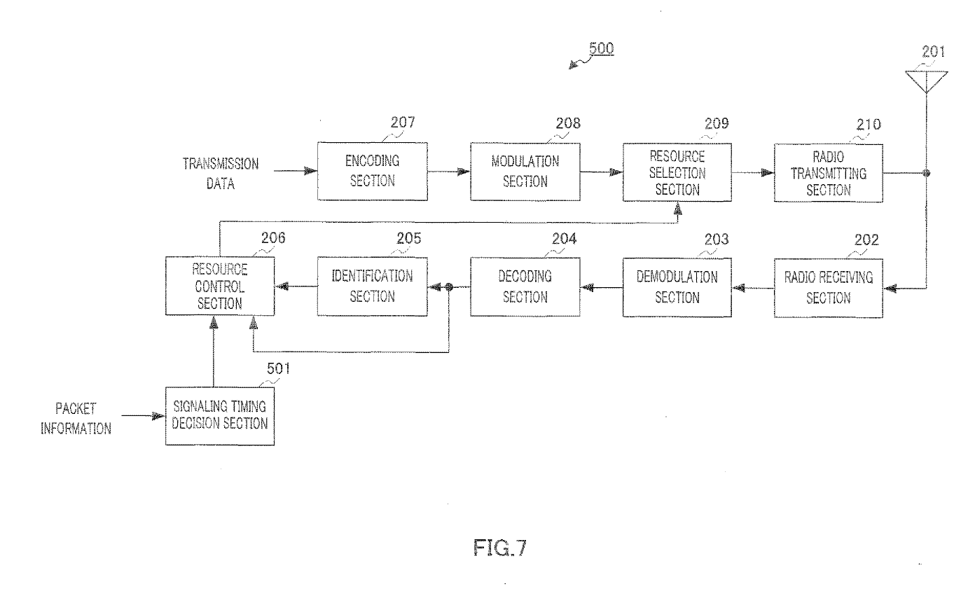

The configuration of UE 500 according to Embodiment 2 of the present invention will now be described using FIG. 7. FIG. 7 is a block diagram showing the configuration of UE 500 according to Embodiment 2 of the present invention. FIG. 7 differs from FIG. 2 in that signaling timing decision section 501 has been added.

Signaling timing decision section 501 has the same kind of function as signaling timing decision section 401 of base station 400, associating scheduling information signaling timing with parameters such as transmission packet TBS, QoS delay, presence or absence of frequency hopping, path loss during transmission/reception, and the like, and deciding signaling timing based on these parameters. The decided signaling timing is output to resource control section 206.

Signaling timing decision sections 401 and 501 need only associate scheduling information signaling timing with any one (but not necessarily only one) of transmission packet TBS, QoS delay, presence or absence of frequency hopping, and path loss during transmission/reception.

Next, a concrete description will be given of the various above-mentioned parameters that are associated with signaling timing by signaling timing decision sections 401 and 501. First, the situation regarding a transmission packet TBS will be described. For a UE with a large TBS—that is, a UE that transmits packets with a large amount of transmission data per packet—a short time interval is set between signaling at the time of an initial transmission and scheduling information signaling at the time of a retransmission. On the other hand, for a UE with a small TBS—that is, a UE that transmits packets with a small amount of transmission data per packet—a long time interval is set between signaling at the time of an initial transmission and scheduling information signaling at the time of a retransmission. Here, the above large and small TBS's denote relative sizes when the two are compared. Similarly, the above long and short time intervals denote relative lengths when the two are compared. The reason for making such settings is as follows.

When the TBS is large, the amount of a resource used per packet transmission is large, and therefore the number of packets that can be transmitted per transmission time unit (for example, per sub-frame) is small. As a result, the number of scheduling information signalings in a system decreases, and a short scheduling information signaling interval can therefore be set. Also, in the case of packets with a large TBS, system throughput is greatly affected, and therefore adaptability to channel fluctuation is increased. That is to say, a short scheduling information signaling interval is set, and appropriate resource allocation is executed in line with channel fluctuation. By this means, system throughput can be improved.

On the other hand, when the TBS is small, the amount of a resource used per packet transmission is small, and therefore the number of packets that can be transmitted per transmission time unit is large. As a result, the number of scheduling information signalings in a system increases, and it is necessary to set a long signaling interval.

Thus, association is performed such that when the TBS is large, a short scheduling information signaling interval is set, and when the TBS is small, a long scheduling information signaling interval is set. By associating scheduling information signaling timing with the TBS beforehand in this way, the inter-packet collision incidence rate can be reduced without generating overhead for reporting scheduling information signaling timing.

Next, the situation regarding transmission packet QoS delay will be described. For a UE whose QoS delay is small—that is, a UE that transmits packets for which the time until a packet is discarded due to transmission delay is short—a short time interval is set between signaling at the time of an initial transmission and scheduling information signaling at the time of a retransmission. On the other hand, for a UE whose QoS delay is large—that is, a UE that transmits packets for which the time until a packet is discarded due to transmission delay is long—a long time interval is set between signaling at the time of an initial transmission and scheduling information signaling at the time of a retransmission. Here, the above large and small QoS delays denote relative sizes when the two are compared. Similarly, the above long and short time intervals denote relative lengths when the two are compared. The reason for making such settings is as follows.

When QoS delay is small, adaptability to channel fluctuation is increased. That is to say, a short scheduling information signaling interval is set, and appropriate resource allocation is executed in line with channel fluctuation. By this means, the number of retransmissions is reduced and the probability of required delay being exceeded and a packet being discarded is lowered, enabling system throughput to be improved.

On the other hand, when QoS delay is large, the time until a packet is discarded is long, and there is therefore a high probability of also being able to tolerate an increase in the number of retransmissions. That is to say, a long scheduling information signaling interval can be set. Therefore, if this is combined with the case in which QoS delay is small, scheduling information signaling overhead can be distributed.

Thus, association is performed such that when QoS delay is large, a long scheduling information signaling interval is set, and when QoS delay is small, a short scheduling information signaling interval is set. By associating scheduling information signaling timing with QoS delay beforehand in this way, the inter-packet collision incidence rate can be reduced without generating overhead for reporting scheduling information signaling timing.

Next, the situation regarding presence or absence of frequency hopping will be described. For a UE in which frequency hopping is not applied, a short time interval is set between signaling at the time of an initial transmission and scheduling information signaling at the time of a retransmission. On the other hand, for a UE in which frequency hopping is applied, a long time interval is set between signaling at the time of an initial transmission and scheduling information signaling at the time of a retransmission. The reason for making such settings is as follows.

In the case of a UE in which frequency hopping is applied, a transmission parameter is decided based on average SINR, and therefore adaptability to instantaneous channel fluctuation is decreased. That is to say, a long scheduling information signaling interval can be set. Therefore, if this is combined with a case in which frequency hopping is not applied, scheduling information signaling overhead can be distributed.

On the other hand, in the case of a UE in which frequency hopping is not applied, a transmission parameter is decided based on instantaneous SINR, and therefore adaptability to instantaneous channel fluctuation is increased. That is to say, a short scheduling information signaling interval is set, and appropriate resource allocation is executed in line with channel fluctuation. By this means, system throughput can be improved.

Thus, association is performed such that when frequency hopping is applied, a long scheduling information signaling interval is set, and when frequency hopping is not applied, a short scheduling information signaling interval is set. By associating scheduling information signaling timing with the presence or absence of frequency hopping beforehand in this way, the inter-packet collision incidence rate can be reduced without generating overhead for reporting scheduling information signaling timing.

Next, the situation regarding path loss during transmission/reception will be described. For a UE for which path loss is small—that is, a UE for which channel attenuation is small and a packet arrives with high reception quality—a short time interval is set between signaling at the time of an initial transmission and scheduling information signaling at the time of a retransmission. On the other hand, for a UE for which path loss is large—that is, a UE for which channel attenuation is large and a packet arrives with low reception quality—a long time interval is set between signaling at the time of an initial transmission and scheduling information signaling at the time of a retransmission. Here, the above large and small path losses denote relative sizes when the two are compared. Similarly, the above long and short time intervals denote relative lengths when the two are compared. The reason for making such settings is as follows.

In the case of a UE for which path loss is small, the amount of resource consumption for signaling scheduling information is small, and therefore the number of UEs for which scheduling information signaling transmission is possible in a system increases. Therefore, adaptability to channel fluctuation is increased—that is, the number of UEs for which a short scheduling information signaling interval can be set can be increased, and system throughput can be improved.

On the other hand, in the case of a UE for which path loss is large, the amount of resource consumption for signaling scheduling information increases since robust transmission is required. As a result, the number of UEs for which scheduling information signaling is possible per transmission time in a system decreases, and it is necessary to set a long signaling interval.

Thus, association is performed such that when path loss is large, a long scheduling information signaling interval is set, and when path loss is small, a short scheduling information signaling interval is set. By associating scheduling information signaling timing with path loss during transmission/reception beforehand in this way, the inter-packet collision incidence rate can be reduced without generating overhead for reporting scheduling information signaling timing.

Thus, according to Embodiment 2, by associating scheduling information signaling timing with parameters such as transmission packet TBS, QoS delay, presence or absence of frequency hopping, path loss during transmission/reception, and the like, and deciding scheduling information signaling timing based on one or more of these parameters, the inter-packet collision incidence rate can be reduced without generating overhead for reporting scheduling information signaling timing.

### Embodiment 3

In above Embodiments 1 and 2, descriptions have been given on the assumption of uplink packet transmission, but in Embodiment 3 of the present invention, a description will be given on the assumption of downlink packet transmission.

A base station allocates a downlink retransmission resource to each UE beforehand, and reports resource allocation information to a UE beforehand. The base station also reports timing of reporting scheduling information to a UE beforehand.

If a UE receives signaling including scheduling information at other than the timing reported beforehand, the UE receives a packet in accordance with the scheduling information. On the other hand, if a UE has not been able to receive scheduling information, the UE receives a packet in accordance with resource allocation information reported beforehand. Also, if a UE has not been able to receive scheduling information at the timing reported beforehand, the UE stops packet HARQ combining.

Thus, according to Embodiment 3, scheduling information signaling timing is reported to a UE from a base station beforehand, and if the UE fails to receive scheduling information at the reported signaling timing, the UE can avoid combining with a reception packet of another UE by stopping packet HARQ combining.

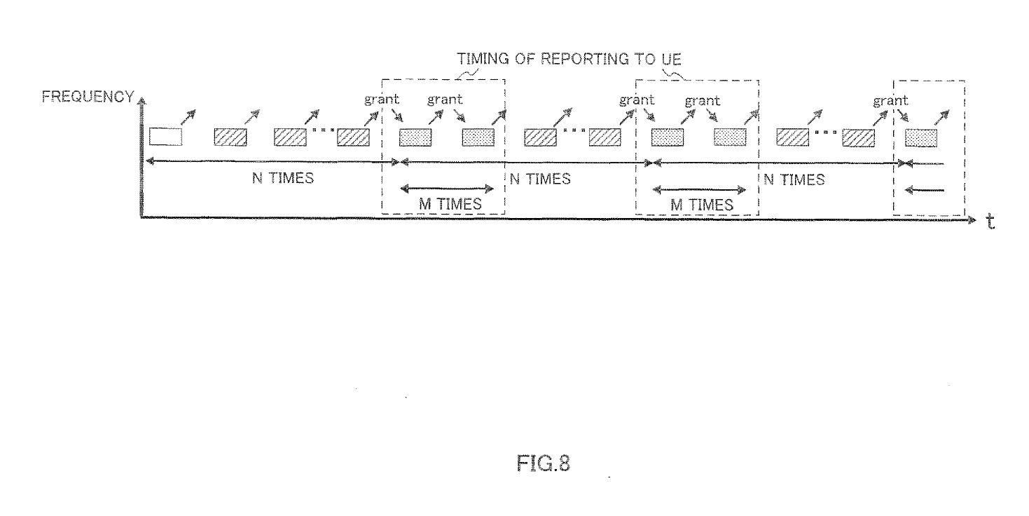

Scheduling information signaling timings described in the above embodiments may also be consecutive retransmission timings, as shown in FIG. 8. By this means, scheduling information reception errors at scheduling information signaling timing can be reduced.

Also, there may be a plurality of scheduling information signaling timings up to a maximum number of retransmissions. Furthermore, scheduling information signaling timing may be set on a cell-by-cell basis.

Scheduling information signaling timing may also be represented by means of a timing that is a reference and a difference from this reference timing. At this time, the reference timing may be reported by means of a broadcasting control channel (for example, a BCH (Broadcast Channel)), while a difference from the reference timing is reported on a UE-by-UE basis. By this means, the number of signaling bits transmitted to each UE can be reduced.

An offset that differs for each UE may also be added to scheduling information signaling timing so that signaling timing is different for each UE in the same cell. By this means, scheduling information signaling timing generation can be distributed over time. Therefore, the probability of scheduling information being transmitted in excess of the number of downlink control channels (for example, PDCCHs (Physical Dedicated Control Channels)) that can be accommodated can be reduced. That is to say, the probability of occurrence of UEs to which scheduling information is not transmitted and that are not scheduled can be reduced, and a fall in throughput can be suppressed.

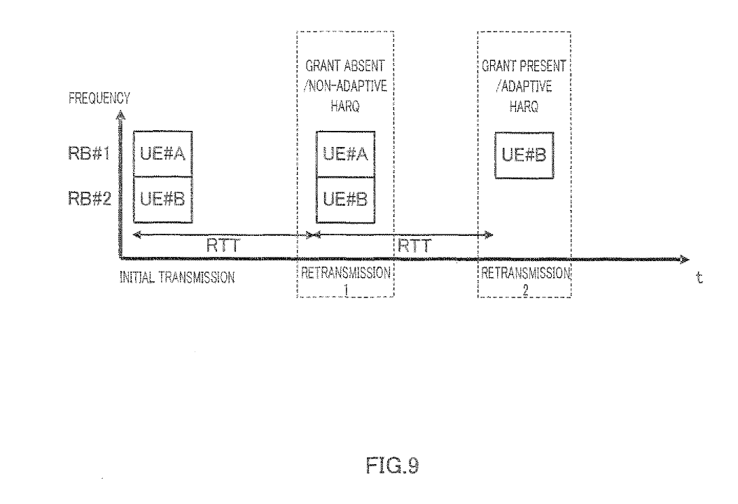

In cases such as when there are few occurrences of packet fragmentation, provision may be made for no scheduling information at all to be transmitted at other than scheduling information signaling timing—that is, for non-adaptive HARQ to be applied—as shown in FIG. 9. By this means, packet collisions between UEs can be avoided at the time of a retransmission.

With regard to the application of non-adaptive HARQ, a method can be conceived of whereby, if a UE has not been able to acquire scheduling information at scheduling information signaling timing, a retransmission packet is transmitted via a predefined resource at the next non-adaptive HARQ retransmission timing. Alternatively, a method can be conceived of whereby, if a UE has not been able to acquire scheduling information, packet transmission is stopped until scheduling information is next signaled.

A base station may also be denoted by “Node B” or “eNode B”.

In the above embodiments, cases in which the present invention is configured as hardware have been described by way of example, but it is also possible for the present invention to be implemented by software.

The function blocks used in the descriptions of the above embodiments are typically implemented as LSIs, which are integrated circuits. These may be implemented individually as single chips, or a single chip may incorporate some or all of them. Here, the term LSI has been used, but the terms IC, system LSI, super LSI, and ultra LSI may also be used according to differences in the degree of integration.

The method of implementing integrated circuitry is not limited to LSI, and implementation by means of dedicated circuitry or a general-purpose processor may also be used. An FPGA (Field Programmable Gate Array) for which programming is possible after LSI fabrication, or a reconfigurable processor allowing reconfiguration of circuit cell connections and settings within an LSI, may also be used.

In the event of the introduction of an integrated circuit implementation technology whereby LSI is replaced by a different technology as an advance in, or derivation from, semiconductor technology, integration of the function blocks may of course be performed using that technology. The application of biotechnology or the like is also a possibility.

The disclosure of Japanese Patent Application No.2008-250616, filed on Sep. 29, 2008, including the specification, drawings and abstract, is incorporated herein by reference in its entirety.

### INDUSTRIAL APPLICABILITY

A radio transmitting apparatus and radio transmitting method according to the present invention are suitable for use in a mobile communication system or the like, for example.

1. A radio transmission apparatus comprising:
a resource control section that generates resource control information for controlling a resource based on a timing of acquiring scheduling information and whether or not said scheduling information is acquired;
a resource selection section that selects a resource based on said resource control information; and
a transmitting section that transmits data using selected said resource,
wherein said resource control section gives an instruction to stop a transmission of said data if said scheduling information is not acquired at said timing.

2. The radio transmission apparatus according to claim 1, wherein said resource control section acquires said scheduling information in an N'th retransmission.

3. The radio transmission apparatus according to claim 1, wherein said resource control section, if said scheduling information is not acquired at said timing associated with a transport block size of data to be transmitted, gives an instruction to stop transmission of said data.

4. The radio transmission apparatus according to claim 1, wherein said resource control section, if said scheduling information is not acquired at said timing associated with a QoS delay of data to be transmitted, gives an instruction to stop transmission of said data.

5. The radio transmission apparatus according to claim 1, wherein said resource control section, if said scheduling information is not acquired at said timing associated with a presence or an absence of a frequency hopping for data to be transmitted, gives an instruction to stop transmission of said data.

6. The radio transmission apparatus according to claim 1, wherein said resource control section, if said scheduling information is not acquired at said timing associated with a path loss during transmission/reception, gives an instruction to stop transmission of said data.

7. A radio transmission method comprising:
generating resource control information for controlling a resource based on a timing of acquiring scheduling information and whether or not said scheduling information is acquired;
selecting a resource based on said resource control information; and
transmitting data using selected said resource,
wherein a transmission of said data is stopped if said scheduling information is not acquired at said timing.
